(19) United States
(12) Patent Application Publication
(10) Pub. No.: US 2026/0351069 A1
(43) Pub. Date: Nov. 5, 2026

(54) ELECTRONIC GAMING SYSTEM USING HISTORICAL RANDOMLY DRAWN SPORT BETTING OUTCOMES

(71) Applicant: Aristocrat Technologies, Inc., Las Vegas, NV (US)

(72) Inventors: Donald Rollo, III, Dacula, GA (US); Cody Herrick, Las Vegas, NV (US); Alisa Mirabal, Henderson, NV (US)

(21) Appl. No.: 19/571,353

(22) Filed: Mar. 18, 2026

Related U.S. Application Data
(63) Continuation of application No. 18/887,864, filed on Sep. 17, 2024.
(60) Provisional application No. 63/554,318, filed on Feb. 16, 2024.

(51) Int. Cl. G07F 17/32

(52) U.S. Cl. CPC G07F 17/3225; G07F 17/3211; G07F 17/3244; G07F 17/3262; G07F 17/3288

(57) ABSTRACT

An electronic gaming machine is provided that includes a display device and a game controller in communication with the display device. The game controller is configured to access historical sporting occurrences that are stored in a database, compile the historical sporting occurrences into winning patterns for an electronic betting game, generate a betting ticket that includes a pattern of identifiers, where a value associated with each identifier is determined randomly based on at least one of the accessed historical sporting occurrences, determine that the betting ticket has at least partially matched one of the winning patterns specified in the electronic betting game, and causing display, on the display device, of an indication that the betting ticket has at least partially matched one of the winning patterns specified in the electronic betting game. Other corresponding methods and computer-readable media are also provided.

### CROSS REFERENCE TO RELATED APPLICATIONS

This application claims priority to and the benefit of U.S. application Ser. No. 18/887,864 filed Sep. 17, 2024, which claims priority to and the benefit of U.S. Provisional Application No. 63/554,318 filed Feb. 16, 2024, the disclosures of which are incorporated in their entirety by this reference.

### BACKGROUND

Electronic gaming machines (“EGMs”) or gaming devices provide a variety of wagering games such as slot games, video poker games, video blackjack games, roulette games, video bingo or lottery games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. Game outcomes are often driven by referencing the output of a random number generator (RNG) running on a microprocessor of the EGM. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. The outcome of each spin of a slot type game is determined by the specific numbers selected by the RNG. The RNG uses a complex mathematical based algorithm for generating the numbers. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

As the sports betting industry continues to evolve there has been an increase in acceptance, adoption, and availability of a subset of in-play wagering that allows players to wager on individual moments in a game in real-time. These so-called “micro bets” allow for in-play wagering and are available in sports such as football, baseball, basketball, tennis, boxing, and mixed martial arts. Examples of micro bets include which player will record the next touchdown or three-pointer, whether a player will make or miss their next shot attempt, whether the next play in a football game will be a rush or pass, a first down, a sack, or a touchdown, etc.

Furthermore, technical innovation has made it more convenient to place sports betting wagers from a player's smart phone, or from a computer terminal connected to the internet. These micro bets can also be combined to create other forms of “exotic bets,” which include parlays, teasers, prop bets, and other forms of micro bets on specific in-game occurrences. This increased adoption and acceptance of sports betting has led to a significant increase in the types of wagers that can be placed on any given sporting event. The introduction of micro-betting and other forms of exotic bets within sporting events has significantly increased the number of different bets that can be made on any single sporting event, beyond merely wagering on the winner of the event. This, in turn, has increased the availability and accessibility of historical sports betting data.

For example, millions of records of historical event data are available from baseball micro-betting data. Other historical sports betting may include Historical Horse Racing (HHR), which allows players to bet on the outcome of past horse racing events. HHR systems often include networked processors or computers (e.g., servers, databases, and wagering terminals) to manage one or more common betting pools in a pari-mutuel wagering environment. In addition to accepting wagers and calculating odds and prices of the wagers, these HHR systems must make pool allocations and maintain separate math models and separate pari-mutuel wagering pools for different denominations and bet levels offered by each of the separate math models.

### BRIEF SUMMARY

As will be described in greater detail below, the present disclosure generally describes electronic gaming systems and methods that are designed to allow wagering on randomly drawn events that are based on historical data.

In one embodiment, an electronic gaming machine is provided. The electronic gaming machine (EGM) may include a display device and a game controller in communication with the display device. The game controller may include at least one processor and at least one memory. The game controller may be configured to access multiple historical sporting occurrences that are stored in a database, where the historical sporting occurrences are tied to at least one historical sporting event and are selected from a group of potential historical sporting occurrences that occurred in the past. The game controller may also compile the accessed historical sporting occurrences into multiple winning patterns for an electronic betting game. The winning patterns each include a calculated odds value of occurring, and the winning patterns are conformed to a specified distribution of odds that is designed to enforce a defined range of possible winning outcomes within the electronic betting game.

The game controller may further generate a betting ticket that includes a pattern of identifiers, where a value associated with each identifier is determined randomly based on at least one of the accessed historical sporting occurrences. The game controller may also determine that the betting ticket has at least partially matched at least one of the winning patterns specified in the electronic betting game and cause display, on the display device, of an indication that the betting ticket has at least partially matched at least one of the winning patterns specified in the electronic betting game.

In some cases, the game controller may further be configured to initiate a settlement payout to the user based on a prize amount associated with the at least partially matched winning patterns in the electronic betting game. In some examples, a selection by the user may randomly populate a grid, as part of the betting ticket, with values for each identifier in the grid. In some embodiments, the historical sporting occurrences may include pitches made in baseball games, and the values for the identifiers in the grid may be randomly populated with pitching outcomes including strike, ball, or in-play.

In some examples, the group of potential historical sporting occurrences may be closed to further sporting occurrences. In other cases, the group of potential historical sporting occurrences may be open to receiving new, historical sporting occurrences based on new sporting events. In some embodiments, the new sporting occurrences may be compiled into the winning patterns in a manner that maintains an initial calculated odds value of occurring.

In some cases, at least one of the winning patterns may be based on a combination of sporting occurrences from a combination of sporting events for different types of sports. In some examples, compiling the accessed historical sporting occurrences into the winning patterns in the electronic betting game may include compiling sporting occurrences from multiple different sports into the winning patterns in the electronic betting game. In some embodiments, different winning patterns may be generated for each of multiple different types of historical sporting occurrences.

In some embodiments, the game controller may further receive a selection from the user as input to the game controller that includes two different types of historical sporting occurrences, and each of the two different types of historical sporting occurrences may include a different number of winning patterns. In some cases, the game controller may access the sporting occurrences in the database via an application programming interface (API) designed to control communication and data access with the database. In some examples, the game controller may initiate a settlement payout to the user via an API that controls communication and data access with an electronic payment system. In some embodiments, the historical sporting occurrences may be implemented by the game controller as a random outcome generator for populating the betting ticket.

In addition to the above-described game controller and electronic gaming machine, a corresponding computer-implemented method may also be provided. The method may include accessing a plurality of historical sporting occurrences that are stored in a database, where the historical sporting occurrences are tied to at least one historical sporting event and are selected from a group of potential historical sporting occurrences that occurred in the past, compiling the accessed historical sporting occurrences into a plurality of winning patterns for an electronic betting game, where the winning patterns each include a calculated odds value of occurring, and where the winning patterns are conformed to a specified distribution of odds that is designed to enforce a defined range of possible winning outcomes within the electronic betting game, generating a betting ticket that includes a pattern of identifiers, wherein a value associated with each identifier is determined randomly based on at least one of the accessed historical sporting occurrences, determining that the betting ticket has at least partially matched at least one of the winning patterns specified in the electronic betting game, and causing display, on the display device, of an indication that the betting ticket has at least partially matched at least one of the winning patterns specified in the electronic betting game.

Still further, a corresponding non-transitory computer-readable medium may be provided that includes one or more computer-executable instructions that, when executed by at least one processor of a computing device, cause the computing device to: access a plurality of historical sporting occurrences that are stored in a database, where the historical sporting occurrences are tied to at least one historical sporting event and are selected from a group of potential historical sporting occurrences that occurred in the past, compile the accessed historical sporting occurrences into a plurality of winning patterns for an electronic betting game, where the winning patterns each include a calculated odds value of occurring, and where the winning patterns are conformed to a specified distribution of odds that is designed to enforce a defined range of possible winning outcomes within the electronic betting game, generate a betting ticket that includes a pattern of identifiers, where a value associated with each identifier is determined randomly based on at least one of the accessed historical sporting occurrences, determine that the betting ticket has at least partially matched at least one of the winning patterns specified in the electronic betting game, and cause display, on the display device, of an indication that the betting ticket has at least partially matched at least one of the winning patterns specified in the electronic betting game.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates an electronic gaming or computing environment in which the embodiments described herein may operate.

FIG. 5 illustrates a flow diagram of an exemplary method for providing a wagering game using historical data.

FIG. 6 illustrates an electronic gaming architecture in which historical sports data is provided to a betting terminal.

FIGS. 7A-7D illustrate embodiments in which a user's outcomes are matched against winning outcomes to determine whether the user is a winner or partial winner.

Throughout the drawings, identical reference characters and descriptions indicate similar, but not necessarily identical, elements. While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

The embodiments herein are generally directed to an electronic gaming system for wagering using historical randomly drawn sport betting outcomes. The electronic wagering system may include an electronic gaming machine (EGM). The EGM may include a display, one or more input devices, a wager acceptor, and a game controller coupled to the display, the input devices, and the wager acceptor. The game controller may be configured to control the display to present various wager options and to determine a selection of one of the wager options associated with a set of awards via one or more of the input devices. The set of awards may be determined based on the results of various historical sporting events.

The proliferation and accessibility of sports betting, and the resulting micro-betting data in connection with historical sports wagers, allows for the creation of a random outcome generating engine. Historical event-driven gaming systems benefit from utilizing alternative sports and micro-betting data. These historical event-driven gaming systems open up math models that do not rely on race participants finishing in a ranked order, or rely on the necessity to make pool allocations, or the necessity to maintain separate math models and separate pari-mutuel wagering pools for different denominations and bet levels offered by each math model.

Various systems and methods may be described herein that generate random outcomes based on previous historical sports betting data. These systems and methods may include retrieving data related to various sporting events that occurred in the past. In some cases, the retrieved data may also include wagering data regarding those events. Each of the historical events (e.g., sports events) may have included multiple participants (e.g., baseball players in a historical baseball game). The wagering data may include information about both the event and its participants. In at least some embodiments, a user may be able to manually select one or more micro bets that make up a wager. In other cases, the system may pre-select each of the bets that make up the wager or “betting ticket” for the user. This betting ticket may then be used in an electronic betting game.

In one embodiment, a wager for an electronic betting game may be made up of baseball pitching data. A prize for the wager may be calculated based on the difference between the predicted outcomes in the wager submitted by the user, and the final outcomes of the participants based on actual historical events. Various EGM terminals, terminal configurations, and user interface aspects related to these systems and methods are also disclosed herein. Still further, at least in some cases, the embodiments described herein may combine elements of a Class II bingo machine with the use of randomly chosen historical pitching data to determine wins and losses.

As noted above, sports betting, including betting on football, baseball, basketball, tennis, boxing, mixed martial arts, etc. has continued to grow in acceptance, adoption and availability. Furthermore, some technical innovations have made it more convenient to place sports betting wagers from a player's smart phone, or from a computer terminal connected to the internet. These advancements in sports betting have led to the availability of a subset of in-play or “in-game” wagering that allows players to wager on individual moments in a game in real-time (often referred to as micro bets). Still further, sports betting has opened up the ability to place “exotic bets” which include parlays, teasers, prop bets, and micro bets on specific in-game occurrences. Exotic bets may be combined with micro bets, creating even more sports betting opportunities for distinct wagers.

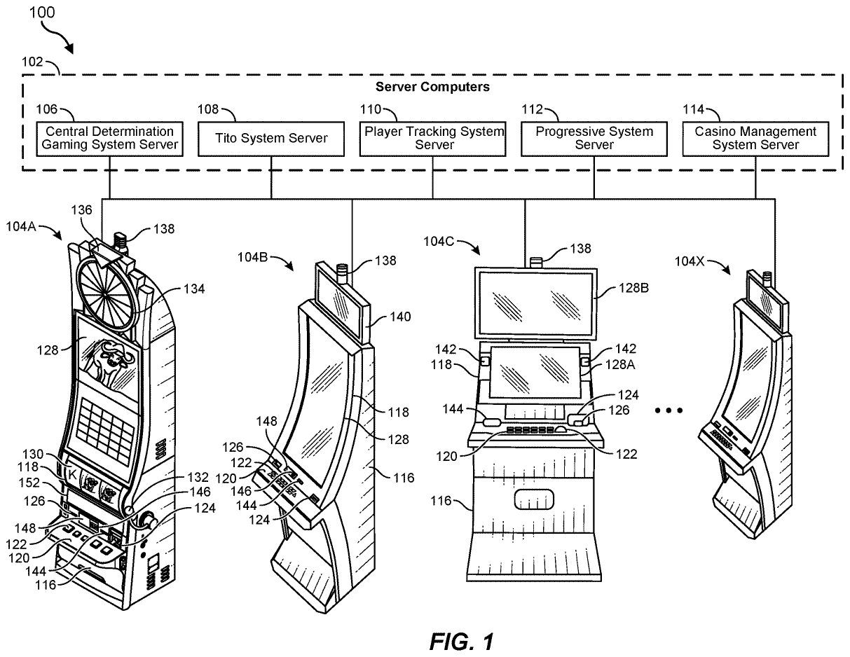

When combined with emerging regulatory environments permitting wagering on sporting events in certain jurisdictions, there has been a significant increase in the types of wagers that can be placed on a given sporting event. The introduction of micro-betting and other forms of exotic bets within sporting events has significantly increased the number of different bets that can be made on any single sporting event, beyond merely wagering on the winner of the event. This, in turn, has encouraged the proliferation and use of historical sports betting data. For instance, in at least some of the embodiments herein, historical major league baseball records tracking historical event data may be used to create a random outcome generating engine. These random outcomes may then be used to populate grids which are matched to users' grids. If the users' grids at least partially match the system-populated grids, the user will win at least a portion of a prize. These embodiments will be explained further below with regard to FIGS. 1-7D.

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

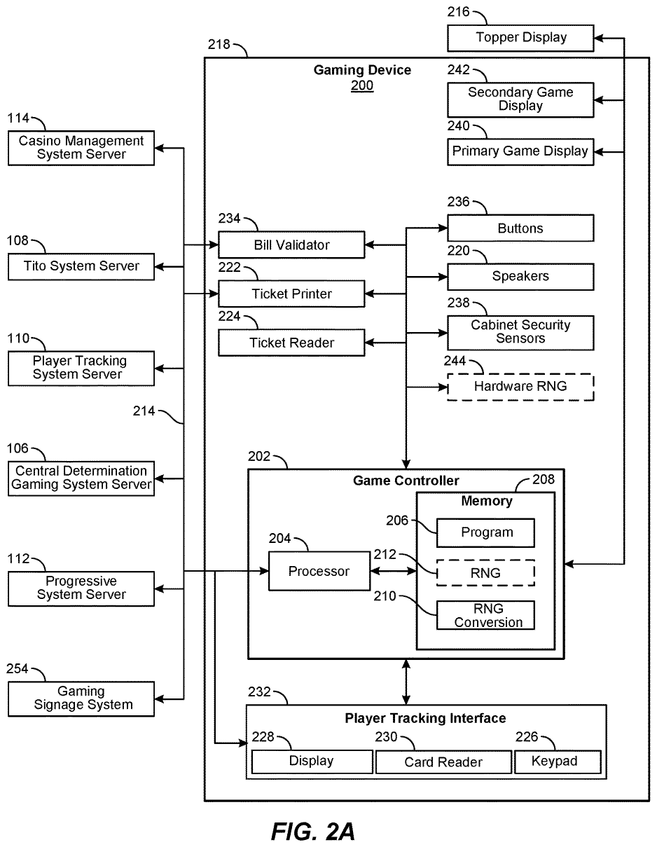

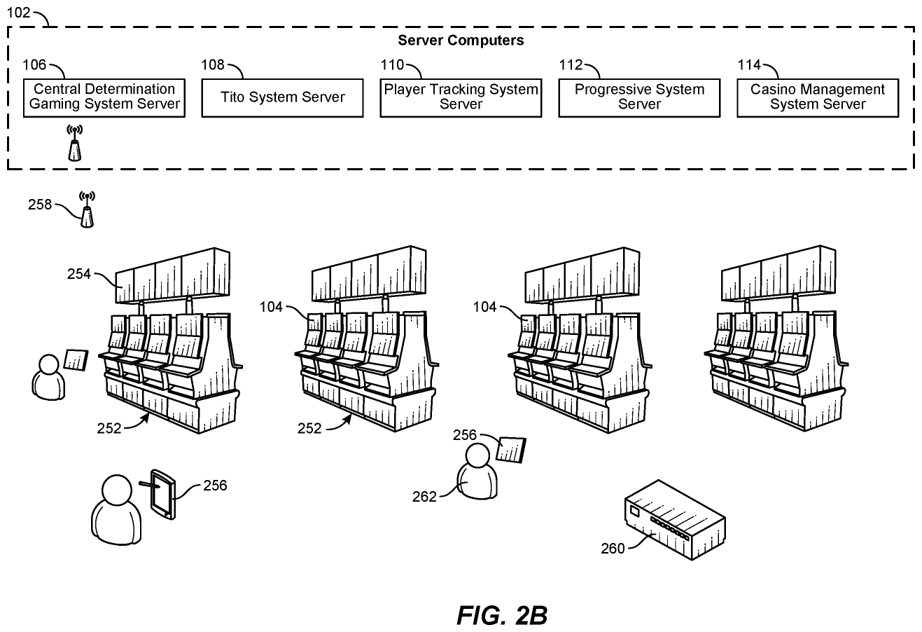

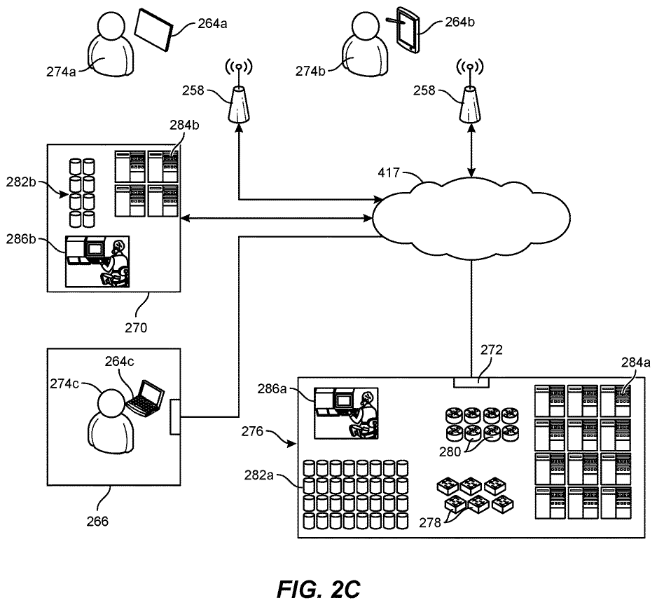

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purposes of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complementary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 270a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

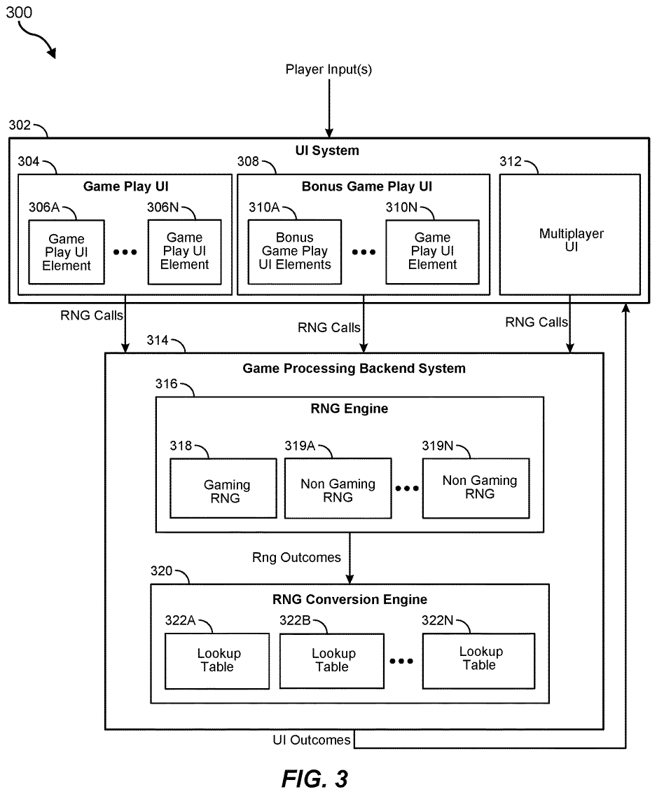

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI elements 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could correspond to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

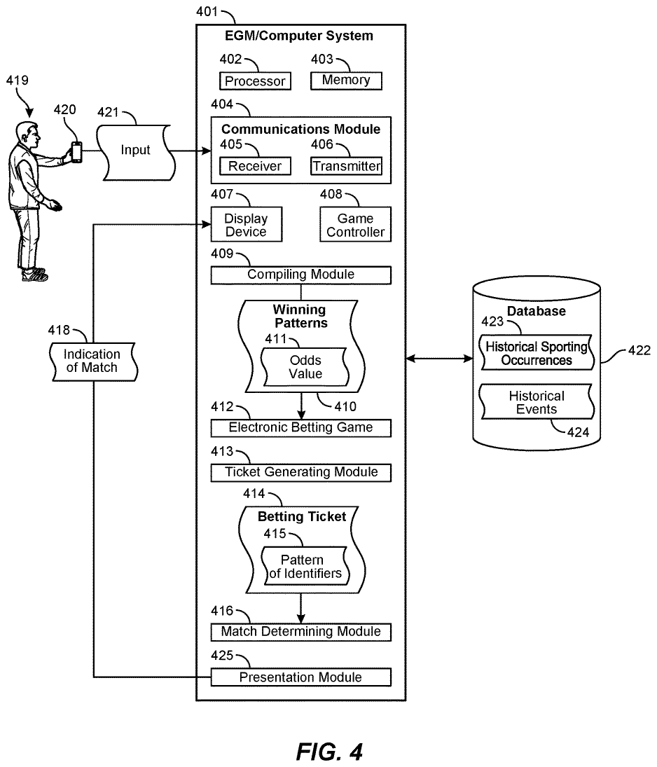

Turning now to FIG. 4, a computing environment 400 is illustrated in which an electronic gaming system is provided that uses historical randomly drawn sports betting outcomes. FIG. 4 includes various electronic components and elements including an electronic gaming machine (EGM) or computer system 401 that is used, alone or in combination with other EGMs or computer systems, to perform associated tasks. The EGM/computer system 401 may be substantially any type of gaming machine or computer system, including a local computer system, a smartphone, a tablet, a personal computer, or a distributed (e.g., cloud) computer system. The EGM/computer system 401 may include at least one processor 402 and at least some system memory 403. The EGM/computer system 401 includes program modules for performing a variety of different functions. The program modules may be hardware-based, software-based, or may include a combination of hardware and software. Each program module uses computing hardware and/or software to perform specified functions, including those described herein below.

In some cases, the communications module 404 may be configured to communicate with other EGMs or computer systems. The communications module 404 may include substantially any wired or wireless communication means that can receive and/or transmit data to or from other computer systems. These communication means may include, for example, hardware radios such as a hardware-based receiver 405, a hardware-based transmitter 406, or a combined hardware-based transceiver capable of both receiving and transmitting data. The radios may be WIFI radios, cellular radios, Bluetooth radios, global positioning system (GPS) radios, or other types of radios. The communications module 404 is configured to interact with databases, mobile computing devices (such as mobile phones or tablets), embedded computing systems, or other types of EGMs/computing systems.

The EGM/computer system 401 may further include a display device 407 and a game controller 408. The game controller 408 may be configured to communicate with the display device 407 to present an electronic betting game 412. The display device 407 may present the electronic betting game 412 and may allow interaction with the betting game via a user interface. The player of the game (e.g., 419) may interact with the display device 407 directly (e.g., via touchscreen) or may interact with the betting game via inputs (e.g., 421) provided through another device (e.g., a smartphone 420 or gamepad or other input device). The game controller 408 may include at least one processor and at least one memory (which may be in addition to or in lieu of processor 402 and memory 403). The game controller 408 may perform a variety of tasks when generating and presenting the electronic betting game 412. These tasks may involve other hardware and/or software modules within the EGM/computer system 401.

For example, the EGM/computer system 401 may include a compiling module 409. The compiling module 409 may be configured to compile historical sporting occurrences 423 that are stored in database 422 (or in other local or remote databases). The historical sporting occurrences 423 may be computer-selected, randomly drawn occurrences that are tied to historical sporting events 424 (e.g., hits, strikes, or balls randomly drawn from a historical baseball game). The compiling module 409 of EGM/computer system 401 may compile these historical sporting occurrences into one or more winning patterns 410 for an electronic betting game 412. The winning patterns 410 may include matching rows, columns, or diagonal squares in a grid, matching random patterns of squares in a grid, or matching other predetermined patterns in a given layout. Each predefined winning pattern 410 may include a calculated odds of occurring (e.g., odds value 411) and may be conformed to a specific distribution of odds. That distribution of odds may be designed to enforce a specified range of possible winning outcomes within the electronic betting game 412.

After the compiling process is complete, the ticket generating module 413 may generate a betting ticket 414 that includes a pattern of identifiers 415 (e.g., numerical values for each box in a grid). Within the pattern of identifiers 415, a value may be associated with each identifier, where the value is determined randomly based on at least one of the accessed historical sporting occurrences. Thus, for example, each box in a grid may be filled with a randomly selected historical sporting occurrence (e.g., hit, ball, strike, football pass completion, basketball steal, etc.) based on the stored historical events 424. In some cases, all of the grid values may be drawn from a single sport, while in other cases, the grid values may be randomly drawn from multiple different sports.

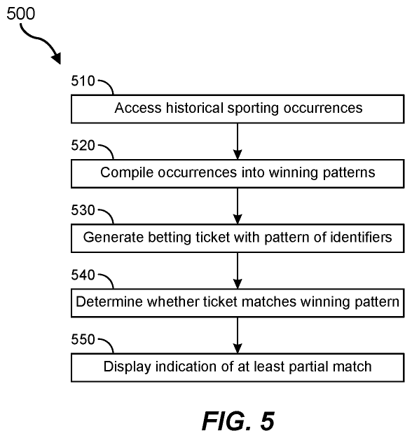

The match determining module 416 may then analyze the user's betting ticket 414 to determine whether the user's ticket has at least partially matched one of the winning patterns 410 specified in the electronic betting game 412. In a grid-based scenario, for instance, the user's betting ticket 414 may include values that match at least some of the randomly selected values or that the user's ticket matches a specific winning pattern of values. If the user's ticket has been determined to be winning, the presentation module 425 may then cause display, on the display device 407, of an indication 418 that the user's betting ticket 414 has at least partially matched at least one of the winning patterns 410. The prizing may be commensurate to the number of overlapping values in the user's betting ticket and the predetermined winning patterns 410. This process flow is described further below with regard FIG. 5.

FIG. 5 is a flow diagram of an exemplary computer-implemented method 500 for wagering using historical randomly drawn sport betting outcomes. The steps shown in FIG. 5 may be performed by any suitable computer-executable code and/or EGM/computing system, including the systems illustrated in FIG. 1-4. In one example, each of the steps shown in FIG. 5 may represent an algorithm whose structure includes and/or is represented by multiple sub-steps, examples of which will be provided in greater detail below.

Method 500 of FIG. 5 includes, at 510, a step for accessing multiple historical sporting occurrences 423 that are stored in a database 422, where the historical sporting occurrences are tied to different historical sporting events 424 and are selected from a group of potential historical sporting occurrences 423 that occurred in those past sporting events. At step 520, method 500 includes compiling the accessed historical sporting occurrences 423 into multiple winning patterns 410 for an electronic betting game 412. The winning patterns 410 may each include a calculated odds value 411 of occurring, and the winning patterns 410 may be conformed to a specified distribution of odds that is designed to enforce a defined range of possible winning outcomes within the electronic betting game 412.

Method 500 next includes, at step 530, generating a betting ticket 414 that includes a pattern of identifiers 415. A value associated with each identifier may be determined randomly based on at least one of the accessed historical sporting occurrences 423. At step 540, the method includes determining that the user's betting ticket 414 has at least partially matched the winning patterns 410 specified in the electronic betting game 412. Then, at step 550, method 500 may include causing display, on a display device 407, of an indication 418 that the user's betting ticket 414 has at least partially matched at least one of the winning patterns 410 specified in the electronic betting game 412.

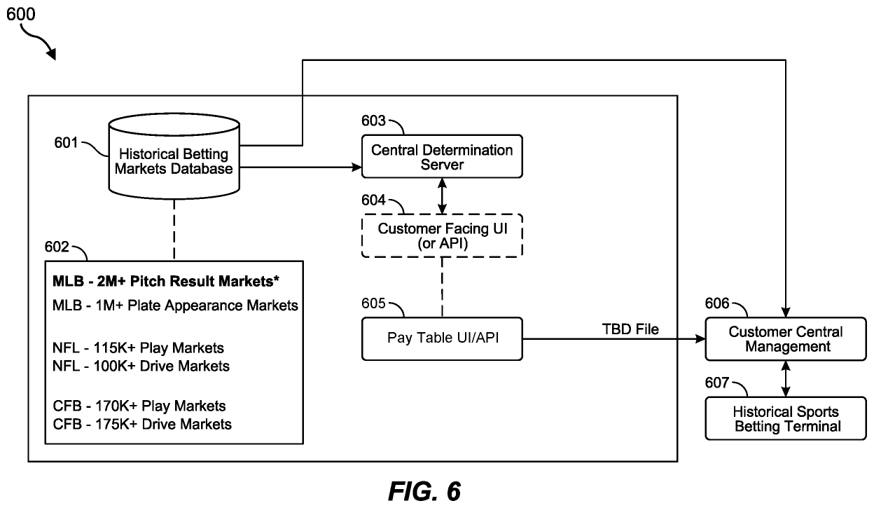

FIG. 6 provides an embodiment of a computing environment 600 in which method 500 may operate. As noted above, the embodiments described herein may provide an electronic gaming system that uses historical micro-betting sports data to generate random outcomes. The random outcomes may be based on historical sporting events, historical sporting statistics, historical sporting overall outcomes, or substantially any sport-related, in-game event or occurrence on which a bet or micro bet could be placed. The central determination server 603 of FIG. 6 may be configured to generate these random outcomes. The central determination server 603 may take the corpus of past sporting events (overall outcomes and/or in-game events 602 stored in database 601) and generate new, randomly drawn sporting outcomes. At least in some cases, the sporting outcomes may be drawn based on a specific set of odds for each past occurrence reoccurring in a gaming simulation. Users may place bets on a simulated game or race outcome or on simulated in-game events that are randomly generated using historical sports data.

The random outcome generation may be managed at the central determination server 603. At least in some cases, the random outcome generation may be managed solely at the central determination server 603 and not at the wagering terminal 607. In such embodiments, the random outcome generation engine may be part of central determination server 603 or may lie on the server side. Gaming establishments may use a customer facing UI 604 and/or a pay table UI/API 605 to upload a specific pay table (or set of pay tables) and/or a specific set of odds that they would like to use in their betting terminals 607. Once the user's betting ticket has been compared to the random outcomes generated by the central determination server 603 and after matches have been identified, the pay table uploaded by the gaming establishment may be used to determine an appropriate prize amount for the user. At least in some cases, the historical sports betting terminal 607 may provide other features specified by the gaming establishment through a customer management system 606.

In this manner, the central determination server 603 may be implemented to process users' incoming wagers. This, it should be noted, is unlike traditional Class III gaming devices, which are self-contained and do not need a central server. Class II gaming devices, as well as the embodiments herein, may implement a server to communicate with the database, perform a random draw (e.g., a bingo draw), and then send results out to various EGMs. In the embodiments herein, the central server 603 may act as a random outcome generator by drawing randomly selected sports occurrences 602 from the past. Random number generation may then be used to pick sporting events (e.g., baseball pitches or basketball shots or football passes) and place the randomly selected sporting events in a grid. If the user's chosen outcomes match the randomly selected sporting outcomes, the user will be at least a partial winner (in games where partial prizes are available for matching at least some of the winning pattern). In this manner, a user playing an electronic betting game may play against randomly generated sporting outcomes as opposed to playing against other players, as would occur in a traditional Class Il game.

In at least some embodiments herein, historical sports betting may be an individual wager against a wagering line. The random outcome generation described above may account for multiple different micro bets, on different sporting occurrences, and even on different games or different sports. The embodiments herein may use micro betting data to provide enough variability to provide a random outcome generator for use in a slot machine. These random outcomes may then be visually represented as reels on a slot game or in another designated manner within an electronic betting game.

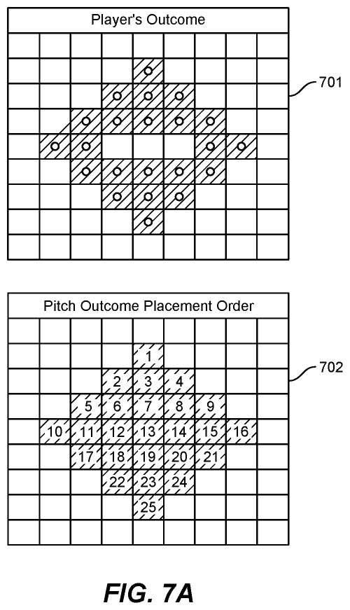

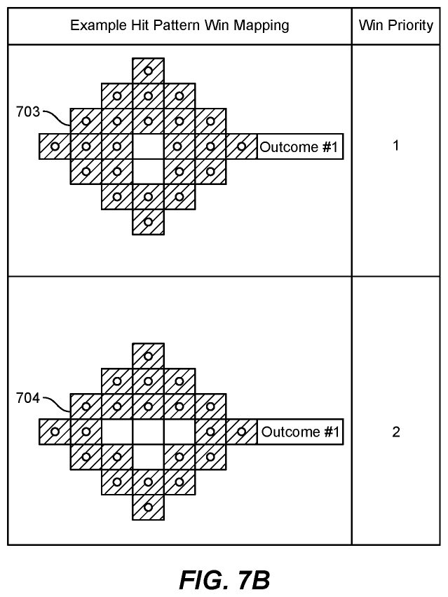

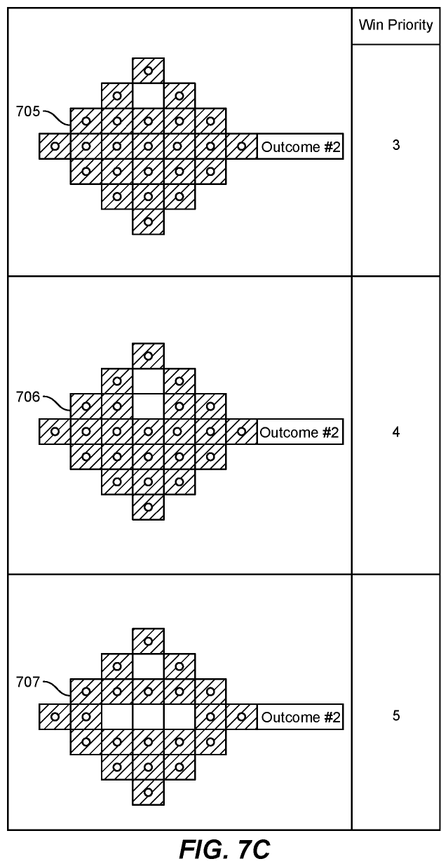

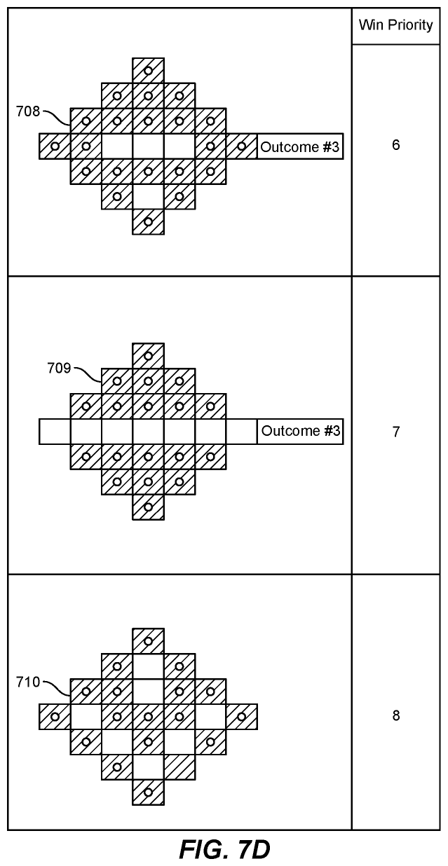

In some embodiments, the central determination server 603 may implement a mathematical model that uses baseball pitching data and corresponding algorithms to generate random sporting outcomes. In this specific example involving baseball, one of three outcomes may be logged for each pitch: a strike, a ball, or “in-play.” At least in some cases, the patterns described in FIGS. 7A-7D may be designed to only look at strikes, as balls and in-play occurrences are much rarer (these, however, may be used in other embodiments). Strikes are, statistically, more common than balls or in-play outcomes in baseball. If the player had an option of choosing between strikes, balls, and in-play pitches when making their selections, they would be less likely to want to play a ball or in-play. Accordingly, the systems herein, at least in some cases, may generate winning patterns for the electronic betting game based on strikes.

In some embodiments, the player of the electronic betting game may initiate a randomized spin. This spin, in turn, may trigger the generation of simulated sporting occurrences, including potentially strike, ball, or in-play occurrences, that are based on past sporting data. In some cases, a single spin or wager may be applied to all (e.g., 25) randomly selected historic pitch results. Randomly drawn sporting outcomes (e.g., baseball pitches in this case (strike/ball/in-play)), may be used to populate a pattern grid (e.g., 701 of FIG. 7A). In some cases, the systems herein may determine a win or a loss by assigning outcomes to a set of prioritized patterns shown in FIGS. 7B, 7C, and 7D. Still further, at least in some cases, the embodiments herein may allow the player to select strike, ball, or in-play on each of the 25 pitches individually, with the option of bulk-selecting if desired.

In some embodiments, the winning patterns may be displayed on at least a portion of a display screen on the EGM (e.g., 401 of FIG. 4). In such cases, the winning pattern may be shown on the display in the form of an alignment of symbols on the screen (e.g., alignment of patterns in a grid or alignment of spinning reels). For example, FIG. 7A illustrates a “Players Outcome” 701 and a “Pitch Outcome Placement Order” 702. The Pitch Outcome Placement Order indicates the order in which randomly selected historical sporting occurrences will be placed in the grid (in this case, positions 1-25). The Player's Outcome indicates grid positions where the user matched a randomly selected occurrence (hashed squares with a circle), and grid positions where no match occurred (blank squares).

At least in some cases, the game controller that is running the electronic betting game may be configured to display multiple different data points or bet-related items on a display or user interface. In FIG. 7B, the game controller may display a user's grid of outcomes 703 and a sports grid or sports score card. The sports score card (e.g., “Example Hit Pattern Win Mapping” 703) may represent a winning outcome that would pay out at a specified amount. The “Outcome” number represents the overall rating or ranking for the outcome. Thus, in the examples shown in FIGS. 7B-7D, Outcomes #1, #2, and #3 may each provide different winning outcomes that pay out at different levels based on how many of the user's hits overlap with the winning patterns.

In the embodiment shown in FIG. 7B, the example winning hit patterns 703 and 704 show that the majority of possible squares 1-25 were matched, resulting in win priorities of 1 and 2, respectively. Other example hit patterns (e.g., 705, 706, and 707) have win priorities of 3, 4, and 5, and are all tied to prizing outcome #2. This indicates that example hit patterns 705, 706, and 707 are equally probable to occur. Still further, example hit patterns 708, 709, and 710 all result in prizing outcome #3, and are associated with priority rankings 6, 7, and 8. Other hit patterns may have even fewer matched grid spaces and may be associated with lower prizing outcomes. In some embodiments, as few as one or two matching squares may be needed to have a winning (or partially winning) ticket. If the user has matched at least a portion of their betting ticket, and their ticket is fully or partially winning, the user's credit meter inside the electronic betting game may be increased to show the user's winnings.

In order to generate the Player's Outcome grid 701 that is then later compared against the winning pattern (e.g., 703), the game controller may receive a wager from a user within the electronic betting game and generate a betting ticket that includes a pattern of identifiers. The value of each identifier may be determined randomly based on the accessed historical sporting occurrences. The game controller may then determine that the user's betting ticket has at least partially matched at least one of the winning patterns specified in the electronic betting game and may cause display, on the display device, of an indication that the user's betting ticket has at least partially matched at least one of the winning patterns specified in the electronic betting game.

In different embodiments, the term “at least partially matched” may have different meanings. For example, one logical or mathematical approach may state that winning patterns are at least partially matched when the winning pattern's spots are a subset of the user's betting ticket pattern's spots. Or, in other cases, a different logical or mathematical approach may state that winning patterns are at least partially matched when the user's betting ticket pattern's spots are a superset of the winning pattern's spots. Examples of at least partial matches are shown in FIGS. 7B-7D.

If the user's board at least partially matches the winning pattern, the game controller may initiate a payout to the user for a certain prize amount. The prize amount may be associated with the (at least partially) matched winning patterns in the electronic betting game. In some cases, the group of potential historical sporting occurrences may be fixed and may be closed to further sporting occurrences (i.e., new games that are played in a sporting season). In other cases, the group of potential historical sporting occurrences may be open to receiving new, historical sporting occurrences based on new sporting events that become historical upon completion. In such cases, the new historical sporting occurrences may be compiled into different winning patterns. In some embodiments, the new historical sporting occurrences may be compiled into the different winning patterns in a manner that maintains a specific calculated odds value of occurring (e.g., as reflected in the “Win Priority” shown in FIGS. 7B-7D).

In some examples, at least one of the winning patterns may be based on a combination of sporting occurrences from a combination of sporting events for different types of sports. For example, a winning pattern may be based on sporting occurrences from baseball games, basketball games, and football games (or other sporting events). In such cases, compiling the accessed historical sporting occurrences into the winning patterns in the electronic betting game may include compiling sporting occurrences from the multiple different sports into the various winning patterns in the electronic betting game. At least in some cases, different winning patterns may be generated for such combinations of sporting events, while single-sport winning patterns may each have their own winning pattern. In some cases, the historical sporting occurrences may be implemented by the game controller as a random outcome generator for populating the user's betting ticket. For example, winning patterns may be chosen ahead of time for single-sport boards or multi-sport boards. The user's game board pattern may be chosen randomly based on historical sports occurrences. Then, matches may be paid out according to how well the user's game board pattern matched the predetermined winning patterns.

Additionally or alternatively, the wager received from the user within the electronic betting game may include two (or more) different types of historical sporting occurrences, and each of the two or more different types of historical sporting occurrences may include a different number of winning patterns. Thus, the user's wager may include selections for football passes, basketball steals, baseball strikes, or selections for other historical sporting occurrences. In this manner, game grids may have values populated with historical sporting occurrences from a wide variety of sports. In other cases, the game grids may have values populated with historical sporting occurrences from a single sport. As noted above with regard to FIG. 6, the game controller may access the various sporting occurrences in a database via an application programming interface (API) designed to control communication and data access with the database. This API may provide access to the historical events of the various sports used to populate the game grid.

In some embodiments, once the system has determined that a prize is to be awarded, the game controller may initiate a settlement payout to the user via a different API that controls communication and data access with an electronic payment system. The payment may include tokens, credits, or other value transferred between a gaming establishment and the user. The game controller may interface with the electronic payment system using the identified API.

In addition to the above-described electronic gaming machine, a corresponding computer-implemented method may also be provided. The method may include accessing a plurality of historical sporting occurrences that are stored in a database, where the historical sporting occurrences are tied to at least one historical sporting event and are selected from a group of potential historical sporting occurrences that occurred in the past, compiling the accessed historical sporting occurrences into a plurality of winning patterns for an electronic betting game, where the winning patterns each include a calculated odds value of occurring, and where the winning patterns are conformed to a specified distribution of odds that is designed to enforce a defined range of possible winning outcomes within the electronic betting game, generating a betting ticket that includes a pattern of identifiers, wherein a value associated with each identifier is determined randomly based on at least one of the accessed historical sporting occurrences, determining that the user's betting ticket has at least partially matched at least one of the winning patterns specified in the electronic betting game, and causing display, on the display device, of an indication that the user's betting ticket has at least partially matched at least one of the winning patterns specified in the electronic betting game.

Still further, a corresponding non-transitory computer-readable medium may be provided that includes one or more computer-executable instructions that, when executed by at least one processor of a computing device, cause the computing device to: access a plurality of historical sporting occurrences that are stored in a database, where the historical sporting occurrences are tied to at least one historical sporting event and are selected from a group of potential historical sporting occurrences that occurred in the past, compile the accessed historical sporting occurrences into a plurality of winning patterns for an electronic betting game, where the winning patterns each include a calculated odds value of occurring, and where the winning patterns are conformed to a specified distribution of odds that is designed to enforce a defined range of possible winning outcomes within the electronic betting game, generate a betting ticket that includes a pattern of identifiers, where a value associated with each identifier is determined randomly based on at least one of the accessed historical sporting occurrences, determine that the user's betting ticket has at least partially matched at least one of the winning patterns specified in the electronic betting game, and cause display, on the display device, of an indication that the user's betting ticket has at least partially matched at least one of the winning patterns specified in the electronic betting game.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

1-20. (canceled)

21. A sports wagering system comprising one or more servers in communication with a user device over a network, the one or more servers including at least one processor configured to:
cause the user device to present graphical elements that represent results of one or more historical sporting occurrences stored in a database;
receive, via the user device, an input for selecting a wager for an online sports wagering game involving the results of the historical sporting occurrences;
select, in connection with the wager for the online sports wagering game, at least one historical sporting occurrence from the historical sporting occurrences stored in the database;
determine a wager outcome based at least in part on the selected wager and the selected historical sporting occurrence; and
transmit, to the user device, an indication of the wager outcome for display to a user.

22. The sports wagering system of claim 21, wherein:
the results of the historical sporting occurrences comprise a statistic associated with a participant of a historical sporting event; and
the graphical elements represent the results of the historical sporting occurrences without identifying the participant.

23. The sports wagering system of claim 22, wherein the processor is further configured to anonymize the participant of the historical sporting event in at least one of the graphical elements.

24. The sports wagering system of claim 23, wherein the processor is further configured to anonymize the participant of the historical sporting event by randomly selecting the historical sporting occurrence in connection with the wager.

25. The sports wagering system of claim 21, wherein:
the results of the historical sporting occurrences are associated with at least one historical sporting event; and
the graphical elements represent the results of the historical sporting occurrences without identifying the at least one historical sporting event associated with the results.

26. The sports wagering system of claim 21, wherein the processor is further configured to select the at least one historical sporting occurrence based at least in part on at least one of:
a random number generator;
a pseudo-random number generator; or
win probabilities.

27. The sports wagering system of claim 21, wherein the processor is further configured to cause the user device to present the graphical elements as at least one of:
reels on a slot game; or
a simulated race based on a historical race outcome.

28. The sports wagering system of claim 21, wherein the processor is further configured to calculate a prize associated with the wager outcome based at least in part on a difference between a set of predicted results in the input and a set of actual results from the selected historical sporting occurrence.

29. The sports wagering system of claim 28, wherein:
the input identifies a selected order of the set of predicted results; and
the processor is further configured to calculate the prize associated with the wager outcome based at least in part on the selected order relative to the set of actual results.

30. The sports wagering system of claim 21, wherein:
the wager comprises a plurality of bets associated with the historical sporting occurrences; and
the processor is further configured to pre-select, for the user, each of the bets associated with the historical sporting occurrences in response to receiving the input.

31. The sports wagering system of claim 21, wherein the processor is further configured to cause the user device to present the graphical elements prior to receiving the input for selecting the wager.

32. A computer-implemented method comprising:
causing, by at least one processor of a sports wagering system, a user device to present graphical elements that represent results of one or more historical sporting occurrences stored in a database;
receiving, by the processor from the user device, an input for selecting a wager for an online sports wagering game involving the results of the historical sporting occurrences;
selecting, by the processor, at least one historical sporting occurrence from the historical sporting occurrences in connection with the wager for the online sports wagering game;
determining, by the processor, a wager outcome based at least in part on the selected wager and the selected historical sporting occurrence; and
transmitting, by the processor to the user device, an indication of the wager outcome for display to a user.

33. The computer-implemented method of claim 32, wherein:
the results of the historical sporting occurrences comprise a statistic associated with a participant of a historical sporting event; and
the graphical elements represent the results of the historical sporting occurrences without identifying the participant.

34. The computer-implemented method of claim 33, further comprising anonymizing the participant of the historical sporting event in at least one of the graphical elements.

35. The computer-implemented method of claim 34, wherein anonymizing the participant of the historical sporting event comprises randomly selecting the historical sporting occurrence in connection with the wager.

36. The computer-implemented method of claim 32, wherein:
the results of the historical sporting occurrences are associated with at least one historical sporting event; and
the graphical elements represent the results of the historical sporting occurrences without identifying the at least one historical sporting event associated with the results.

37. The computer-implemented method of claim 32, wherein selecting the historical sporting occurrence comprises selecting the historical sporting occurrence based at least in part on at least one of:
a random number generator;
a pseudo-random number generator; or
win probabilities.

38. The computer-implemented method of claim 32, wherein causing the user device to present the graphical elements comprises causing the user device to present the graphical elements as at least one of:
reels on a slot game; or
a simulated race based on a historical race outcome.

39. The computer-implemented method of claim 32, further comprising calculating a prize associated with the wager outcome based at least in part on a difference between a set of predicted results in the input and a set of actual results from the selected historical sporting occurrence.

40. A non-transitory computer-readable medium comprising one or more computer-executable instructions that, when executed by at least one processor of a sports wagering system, direct the sports wagering system to:
cause a user device to present graphical elements that represent results of one or more historical sporting occurrences stored in a database;
receive, via the user device, an input for selecting a wager for an online sports wagering game involving the results of the historical sporting occurrences;
select, in connection with the wager for the online sports wagering game, at least one historical sporting occurrence from the historical sporting occurrences stored in the database;
determine a wager outcome based at least in part on the selected wager and the selected historical sporting occurrence; and
transmit, to the user device, an indication of the wager outcome for display to a user.
